(19) United States
(12) Patent Application Publication
(10) Pub. No.: US 2004/0201000 A1
(43) Pub. Date: Oct. 14, 2004

(54) Polymer blends for optical amplification

(75) Inventors: Robert A. Norwood, West Chester, PA (US); Anthony F. Garito, Radnor, PA (US); Anna Panackal, Philadelphia, PA (US)

Correspondence Address: Min, Hsieh & Hack LLP, c/o PortfolioIP, P.O. Box 52050, Minneapolis, MN, 55402, US

(73) Assignee: Photon-X, Inc., Malvern, PA (US)

(21) Appl. No.: 10/762,248

(22) Filed: Jan. 23, 2004

Related U.S. Application Data
(63) Continuation of application No. 09/722,282, filed on Nov. 28, 2000, now abandoned.
Application No. 09/722,282 is a continuation-in-part of application No. 09/507,582, filed on Feb. 18, 2000, now Pat. No. 6,292,292.
(60) Provisional application No. 60/120,876, filed on Feb. 19, 1999.

(51) Int. Cl. G02B 5/02

(52) U.S. Cl. 252/582

(57) ABSTRACT

The present invention provides a polymer blend comprising a general composition including a rare earth element, an elements of Group VI_{A} an elements of Group V_{A} a first fully halogenated organic group a second fully halogenated organic group, and one of a perfluoropolymer, a flouropolymer, and an optical polymer. Methods of forming the polymer blend are also disclosed.

### CROSS-REFERENCE TO RELATED APPLICATION

The present application is a continuation-in-part of co-pending application Ser. No. 09/507,582, filed Feb. 18, 2000.

### STATEMENT REGARDING FEDERALLY FUNDED SPONSORED RESEARCH OR DEVELOPMENT

The U.S. Government has a paid-up license in this invention and the right in limited circumstances to require the patent owner to license others on reasonable terms as provided for by the terms of Contract No. N00014-00-C-0117 awarded by the Department of the Navy.

### DESCRIPTION OF THE INVENTION

The present invention generally relates to metal containing polymer compositions. In particular, this invention relates to polymer fiber optics and to polymer blends for use in fiber optics.

As fiber optics are increasingly employed in long distance communications, metropolitan network and local access communications, there is an increasing need for efficient, compact optical amplification.

Optical communication systems based on glass optical fibers (GOFs) allow communication signals to be transmitted not only over long distances with low attenuation but also at extremely high data rates, or bandwidth capacity. This capability arises from the propagation of a single optical signal mode in the low-loss windows of glass located at the near-infrared wavelengths of 0.85, 1.3, and 1.55 μm. Present technology has moved to erbium doped fused silica fiber for optical amplification. Since the introduction of erbium-doped fiber amplifier (EDFA), the last decade has witnessed the emergence of single-mode GOF as the standard data transmission medium for wide area networks (WANs), especially in terrestrial and transoceanic communication backbones. In addition, the bandwidth performance of single-mode GOF has been vastly enhanced by the development of dense wavelength division multiplexing (DWDM), which can couple up to 160 channels of different wavelengths of light into a single fiber, with each channel carrying gigabits of data per second. Moreover, a signal transmission of 1 terabit (10¹² bits) per second was achieved over a single fiber on a 100-channel DWDM system. Enabled by these and other technologies, the bandwidth capacities of the communication networks are increasing at rates of as much as an order of magnitude per year.

The success of single-mode GOF in long-haul communication backbones has given rise to the new technology of optical networking. The universal objective is to integrate voice, video, and data streams over all-optical systems as communication signals make their way from WANs down to smaller local area networks (LANs), down to the curb (FTTC), home (FTTH), and finally to the end user by fiber to the desktop (FTTD). Examples are the recent explosion of the Internet and use of the World Wide Web, which are demanding higher bandwidth performance in short- and medium-distance applications. Yet as the optical network nears the end user, starting at the LAN stage the system is characterized by numerous fiber connections, splices, and couplings, especially those associated with splitting of the input signal into numerous channels. All of these introduce optical loss. To compensate for the loss penalty, current solutions rely on expensive EDFAs that are bulky at fiber lengths of about 40 m. The cost of a typical commercial EDFA can reach many tens of thousands of dollars. Thus, to complete the planned build-out for FTTC, and FTTD in the U.S. would require millions of amplifiers and hundreds of billions of dollars.

An EDFA module is made up of a number of components. One of the most critical components in the module is the erbium doped silica fiber (EDF). Present EDF is limited by low concentrations of erbium atoms (maximum is about 0.1%), clustering that leads to quenching of photoluminescence, a relatively narrow emission band, a highly wavelength dependent gain spectrum, and an inability to be fabricated in a compact, planar geometry. Efforts have been directed toward the use of other rare earth ions in both fused silica glass hosts and other glasses including fluoride, tellurite and phosphate glasses. To this point, these efforts have been limited by the fundamental materials properties of these glass media with regard to their ability to dissolve rare earth atoms, mechanical properties, thermal stability, and other key properties.

Certain embodiments of the present invention comprise rare earth fluorphosphinate polymer material that comprise the following preferred properties:

compatibility with a broad range of rare earths that enable coverage of the full 1500 to 1600 nm window (and beyond) using a common host platform;

very high concentrations of rare earth elements without associated quenching and upconversion penalties, allowing for short lengths of fiber to be used as small as centimeters and less;

low intrinsic optical loss;

capable of being drawn into single mode optical fiber; and

a capable of being cast into films for planar waveguide applications.

Cost effective, compact integrated optics is a solution to this problem, but currently is non-existent. Resulting is the need for very long lengths of this fiber (tens of meters) in actual use. There is a need for an efficient, compact, broadband amplifying medium to accommodate lower power pumping, reduce packaging problems, and increase network capacity.

It would also be beneficial to provide novel optical waveguide materials that are easy to process using standard silicon VLSI (very large scale integration) fabrication methods and optical fiber drawing processes. Further, it would also be beneficial to produce a fiber amplifier and material therefore having low-loss in short and medium distance communications network systems. Additionally, it would be beneficial to produce an integrated optical component that is a low-loss splitter that combines amplification and splitting of the input signal while maintaining a high signal-to-noise ratio.

Efficient broadband amplifiers are required for the continued expansion of optical networks used in telecommunications and data communications. Known optical amplifiers are based on fuse silica or other glasses doped with the rare earth ion erbium and amplify in the 1550nm window, notably, in the conventional (“C”) band from about 1530 nm to about 1560 nm and in the long (“L”) band from about 1570 nm to about 1600 nm. However, some problems associated with this approach include narrow bandwidth, difficult handling, high temperature processing, and difficulty in achieving planar waveguide embodiments that naturally lend themselves to next generation devices such as loss less optical switches and splitters. In addition, it has been difficult to apply this approach to other dopants that can potentially provide amplification in other, regions of fiber optic transparency, (see FIG. 1).

A clear need exists for broadband amplifying media that provide access to the full transparency window form about 1270 nm to about 1650 nm. It would also be beneficial to provide amplifying media that would broaden amplifier bandwidth, both in the erbium window 110 and other lanthanide series rare earth windows 120, 130, and 140 as shown in FIG. 1. It would also be beneficial for the media to allow straightforward processing via conventional low temperature fiber, film, and lithographic processes and to have improved mechanical and chemical resistance compared to known glass amplifying media. It would be further beneficial for the media to lend itself to direct integration via planar waveguide embodiments.

### SUMMARY OF THE INVENTION

In accordance with the invention, briefly, the present invention provides a polymer blend comprising a rare earth element, an element of Group VI_{A}, an element of Group V_{A}, a first fully halogenated organic group, a second fully halogenated organic group, and at least one of a perfluoropolymer, a flouropolymer, and an optical polymer.

In another embodiment, there is a polymer blend formed by blending a solid rare earth perfluoropolymer and a solid copolymer. The rare earth perfluoropolymer also comprises a first rare earth element, a second rare earth element, one of the elements of Group VI_{A}, one of the elements of Group V_{A}, a first fully halogenated organic group, and a second fully halogenated organic group. The rare earth perfluoropolymer and the copolymer may be blended in a shearing process.

In another embodiment there is a polymer blend formed by dissolving a rare earth perfluoropolymer in a first solvent. The rare earth perfluoropolymer comprising at least one unit comprising a rare earth element, one of the elements of Group VI_{A}, one of the elements of Group V_{A}, a first fully halogenated organic group, a second fully halogenated organic group. Certain embodiments include forming a first solution and dissolving a copolymer in a second solvent to form a second solution, the first and second solvents may be miscible cosolvents, combining the first and second solutions, and removing the first and second solvents.

In the embodiments provided, first and second rare earth elements can be the same or different rare earth element. Additionally, where a first and second fully halogenated organic group is provided, the first and second halogenated organic groups can be the same or different halogenated organic group.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a diagram of polymer blends for optical amplification;

FIG. 2 is an energy level diagram for a rare earth codopant emitter; and

FIG. 3 is the chemical structure of a rare earth polymer; and

FIG. 4 is an energy level diagram of a rare earth as a chromophore.

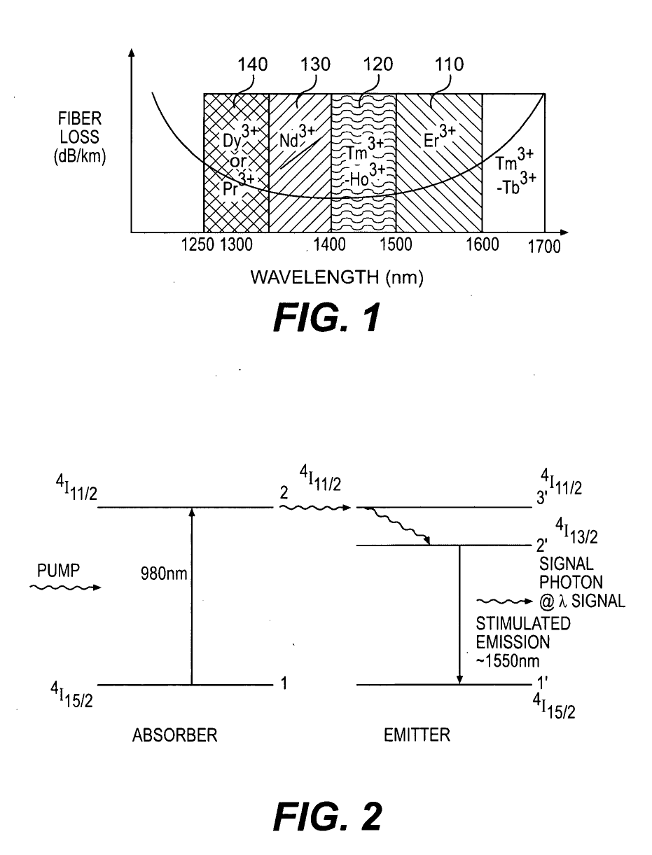

### DESCRIPTION OF THE EMBODIMENTS

Reference will now be made in detail to embodiments of the invention, examples of which are illustrated in the accompanying drawings. Wherever possible, the same reference numbers will be used throughout the drawings to refer to the same or like parts.

Reference will now be made in detail to specific exemplary embodiments of the invention. Wherever possible, the same reference numbers will be used throughout the description to refer to the same or like parts. The invention is described using preferred embodiments. However, one of ordinary skill in the art will recognize that the principles of the present invention apply to other types of polymers.

Reference is made herein to U.S. patent application Ser. No. 09/507,582, filed Feb. 18, 2000, and Serial No. [Attorney Docket No. 07033.0008] filed Nov. 28, 2000, which are assigned to the assignee of the present invention, and are incorporated herein by reference in their entireties.

In an embodiment of the invention there is a rare earth polymer composition comprising,

{X(DDZRR′)₃}ₙ (1)

where X comprises at least one rare earth element or aluminum.

In another embodiment the rare earth polymer comprises,

{XY(DDZRR′)₃}ₙ (2)

where X and Y can be at least one rare earth element or aluminum, and X and Y may be the same or different.

Another embodiment of the present invention for the rare earth polymer composition comprises,

{XY(OOPRR′)₃}ₙ (3)

where X and Y, which are the same or different, are a rare earth element or aluminum. Suitable rare earth elements include lanthanum, cerium, praseodymium, neodymium, promethium, samarium, europium, gadolinium, terbium, dysprosium, holmium, erbium, thulium, ytterbium, and lutetium. All other rare earth element are also within the contemplation of the invention and not intended to be excluded.

For the composition of formulas (1) and (2), D is a Group VI element of the periodic table. In an embodiment D can be oxygen or sulfur. Also, for these formulae, Z is a Group V element of the periodic table. And in certain embodiments of the invention, Z can be nitrogen or phosphorous.

Typically, R is a fully halogenated organic group, and R′ is another fully halogenated organic group which is the same or different from R. R and R′ can be fluoroalkyl chains of the formula CₓF_{y}, where y=2x+1, where x≧1 and R═R′ or R does not equal R′. In certain embodiments, x is 6 or 8. Generally, n is an integer greater than 1 or can be 1

Generally, in the first and second fully halogenated organic groups (R and R′) the halogens may be fluorine, chlorine, bromine or mixtures thereof. In certain embodiments, the first and second fully halogenated organic group contain fluorine. Another embodiment is a hexafluorophenoxy group having the formula C₆F₅O.

When designing an optical amplifying medium, potential nonradiative decay pathways are considered. The excited rare earth atoms must be prevented from nonradiatively returning to their ground state via coupling to vibrational modes in the surrounding medium. This can be accomplished by having the vibrational modes present, have low energies (for example, less than 1000 cm⁻¹). A controlled microscopically engineered method for this may be to incorporate a rare earth element in an organic or inorganic polymer that has exclusively low energy vibrations. Since high vibrations are generally caused by the presence of light atoms, the most direct method of achieving this goal is to eliminate light atoms such as hydrogen from the medium. This is accomplished, for example, in the newly developed rare earth doped perfluoropolymers..

Given a rare earth doped polymer, improvements in processing can be realized by blending the polymer with perfluoropolymers including, foe example, poly[2,3-perfluoroalkenyl)perfluorotetrahydrofuran] known by the Trademark CYTOPO® (Asashi Glass), Poly[2,2-bistrifluoromethyl-4,5-difluoro-1,3-dioxole-co-tetrafluoroethylene] known by the Trademark TEFLON® AF (DuPont), or optionally with fluoropolymers including tetrfluoroethylene/hexafluoropropylene/vinylidene copolymers hereinafter referred to as THV® (3M), fluorinated polyimides, fluorinated acrylates, fluorinated methacrylates, fluorinated polyarylethers, or high quality optical polymers such as polymethylmethacrylate, polystyrene, polycarbonate, and norbornene polymers.

The term element used herein is understood to include ions, atoms, isotopes, and species of atoms of the Period Table.

In certain embodiments of the invention, the rare earth doped halogenated polymers described, incorporate rare earth elements in a covalently bonded polymer chain. In such embodiments, deleterious effects such as clustering and upconversion quenching are reduced. Certain embodiments of the present invention involve the use of selected energy transfer rare earth element codopants that increase the overall absorption for pumping radiation and can transfer that absorbed radiation to rare earth elements that luminesce at wavelengths of interest. These codopants can be incorporated at a continuum of desired levels, providing for more control over the ratio of codopant elements to luminescing elements. For a given desired amplifier performance, the copolymer composition can be tuned to optimize the pump radiation absorbed, device length, luminescence efficiency, and nose figure in the amplifier. High percentages of codopant and luminescing rare earth elements can be incorporated (up to 5-15%).leading to very high gains per unit length, resulting from increased pump absorption and/or efficient luminescence. In certain embodiments the polymer medium provides a broader gain spectrum than glass media owing to nonhomogeneous broadening, thereby leading directly to a broader band amplifier.

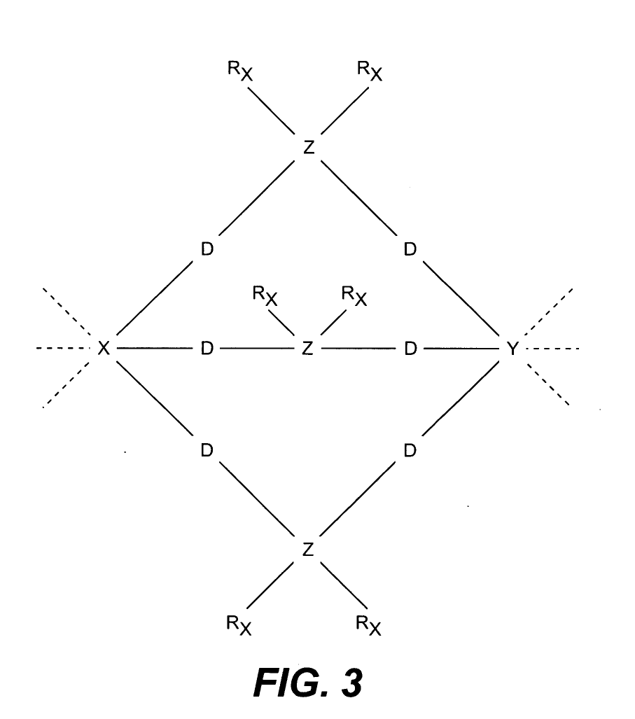

The codopant polymers of some embodiments are made via a condensation type of polymerization in suitable organic solvents for example lower alkyl keytones, lower alkyl ethers, such as acetone. The sodium salt of a fully halogenated substituted phosphinic or nitric acid may be added to a mixture of rare earth chlorides, XCl₃ and YCl₃, where X and Y may be the same or different elements and are chosen from, lanthanum, cerium, praseodymium, neodymium, promethium, samarium, europium, gadolinium, terbium, dysprosium, holmium, erbium, thulium, ytterbium, lutetium and aluminum. The solid that results is stirred under nitrogen for about 72 hours at room temperature. Distilled water is then added to the reaction mixture which is boiled to remove the sodium chloride, and filtered and washed with boiling water repeatedly. The washed product is then dried in a vacuum oven. The resultant polymers, as shown in FIG. 3, are soluble in organic solvents such as dimethyl acetamide and are also high temperature processible.

In FIG. 3, X and Y are the same or different rare earth elements such as lanthanum, cerium, praseodymium, neodymium, promethium, samarium, europium, gadolinium, terbium, dysprosium, holmium, erbium, thulium, ytterbium, and lutetium as well as aluminum. In certain embodiments X and Y are different elements, with a ratio of X:Y often in the range between 1:1 and 1:50, but more preferably, approximately 1:10. Although X and Y are often different elements, those skilled in the art will recognize that X and Y can be the same elements.

Still referring to FIG. 3, D is typically an element from Group VI_{A} on the Periodic Table. In an embodiment, D is one of oxygen and sulfur. In another embodiment, selenium can also be used. Z may be an element from Group V_{A} on the Periodic Table. In certain embodiments, Z is phosphorous. Although not as preferred as nitrogen and phosphorous, arsenic can also be used.

Still referring to FIG. 3, R and R′ can each be a fully halogenated group. The halogen is fluorine, chlorine, bromine, and may be mixtures thereof. In an alternative embodiment, the first and second halogenated organic group consists of fluorine. More preferably, the halogenated oxygenated group is a fluoroalkyl chains of a general composition CₘF₂ₘ₊₁ where m≧1. Preferably, R equals R′, although those skilled in the art will recognize that R can be different from R′. Also, n is an integer greater than or equal to 1.

On method of making the polymer is by blending. Blending may be accomplished by solution in either a suitable solvent or cosolvent, via conventional engineering plastic processes. Examples include, extrusion or direct blending of monomer species that are then polymerized in situ. By such conventional polymer processing techniques, the resulting blend can be formed into articles such as thin films, optical fiber preforms, molded optical waveguides, and optical fibers among others. Optical amplification efficiencies in these blends will be effected by the morphology and structure of the underlying polymers, their tendency to interact, the vibrational energy spectra of the constituent polymers, the homogeneity of the blend as it effects optical loss, refractive index, and polarization dependent effects. Certain embodiments of the present invention achieve an amorphous polymer structure.

Exemplary embodiments of the invention include:

1. Solvent born blends of one or more rare earth perfluoropolymers and perfluoropolymers, fluoropolymers, or optical polymers in which the various polymers have a common solvent or miscible cosolvent system.

2. Blends of powders/pellets of the polymer substituents via conventional shearing processes such as twin screw extrusion, in which these substituent polymers have comparable processing windows.

3. Chemical blending of respective monomers with the intent of polymerizing the mixture in situ. In certain embodiments, the mixture is neat.

In embodiment 1, for example, dimethyl acetamide (DMAC) can be used as a common solvent for the rare earth perfluoropolymers and THV copolymers of particular compositions. The THV copolymer and the rare earth perfluoropolymer are separately dissolved in DMAC, and the resulting solutions are then combined with the THV to rare earth perfluoropolymer, the ratio being about 6:1 in weight percentage subsequent to solvent evaporation. The resulting solution can be directly spin coated onto suitably prepared substrates such as silicon, glass, or polymers. The thin films formed can then be patterned by conventional lithographic processes or by molding techniques.

The compositions identified above may be used to produce cores for optical fibers. The cores can be cladded with suitable materials having a lower refractive index than the core. The core/cladding refractive index difference is small enough to result in single optical mode propagation for optical wavelengths from about 1200 to about 1700 nm. Further, the compositions identified can be used to produce an optical amplifying film, containing a substrate, a buffer film, a guiding layer, and an upper cladding film. The refractive indices of the buffer film and the upper cladding film are less than that of the guiding layer film, with the resulting waveguide guiding a single optical mode for optical wavelengths from 1200-1700 nm.

Rare earth (RE) waveguide amplifiers operate on the basic 3-level and 4-level laser transition principles. The single pass gain of the waveguide amplifier is the fundamental parameter to be calculated. Amplification in a RE polymer waveguide, as with most types of laser systems, can be described with a 3-level model. FIG. 2 displays the energy level diagram of such a model for Er³⁺ ion.

In an amplifier, the RE ions start out in their ground state, level 1. The electrons are then excited to level 2 by a pump beam of photons with energy hωₚ equal to the transition energy from level 1 to level 2. The ions subsequently undergo fast nonradiative decay to level 3, which is the metastable state of the system. The lifetime of this state is very long in comparison to the nonradiative decay. As a consequence, a population inversion is created in level 3. Then, as a signal beam passes by the ions, it stimulates emission of photons with the same signal energy, hωₛ. This stimulated decay is from level 3 to level 1, the ground state.

The RE ion is encapsulated as a chromophore which has the ability to control the manifold of electronic excited states. In certain embodiments, an optical energy transfer mechanism between the surrounding organic ligands of the chromophore unit and the central RE element is provided in which the RE excited state can be populated through selective absorption (“light harvesting”) by the chromophore ligand and subsequent energy transfer to the RE site. This transfer can approach unit efficiency, and, as a result, can increase the absorption cross-section by 10⁴-10⁵ times that of bare RE ions.

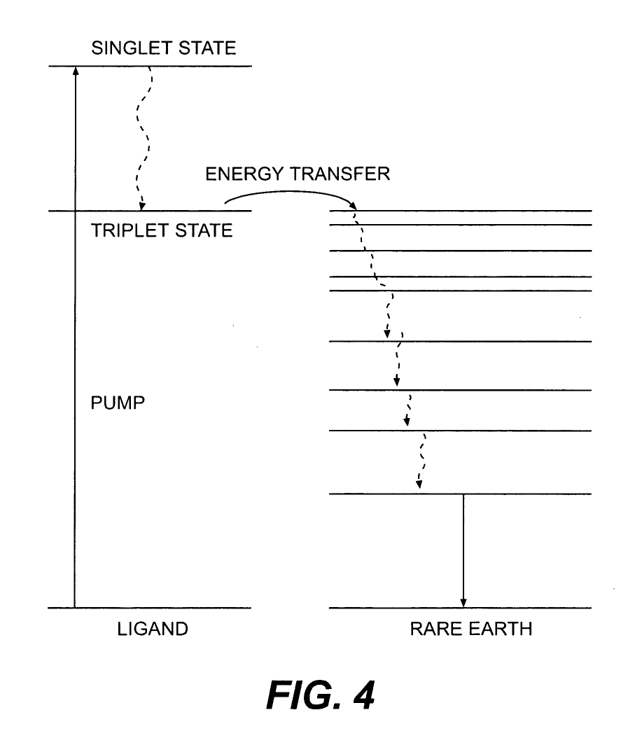

The process is diagrammed in FIG. 4, and shows how the chromophore ligand singlet band is first excited by pump light and then decays nonradiatively through inter-system crossing (IC) to its bottleneck triplet state. Radiative transitions back to the ground state are spin forbidden and, hence, the chromophore ligand can relax through energy transfer to the encapsulated RE ion. This energy transfer is increased by tuning the energy gap, again through chromophore design, between the ligand triplet state and the upper level of RE fluorescing transition.

Output intensity of the transmitted signal is determined by the optical attenuation coefficient of an optical waveguide. The various factors contributing to optical loss in optical polymers can be divided into intrinsic and extrinsic loss. Intrinsic loss includes vibrational absorption of the polymer materials, electronic transition absorption, and Rayleigh scattering. Extrinsic loss includes absorption due to impurities, scattering from dust and microvoids, and imperfections in fiber parameters. Extrinsic loss is related to materials processing and fiber fabrication, and thus can be reduced by perfecting each procedure. Intrinsic loss is material related and cannot be reduced without drastic changes in material composition.

Standard optical polymer materials are based on hydrocarbon (C—H) structures. A prototypical example is polymethylmethacrylate (PMMA) which has three principal loss windows located at 570, 650, and 780 nm between absorption maxima arising from C-14 vibrational overtone modes. In high optical quality samples, the principal window at 650 nm exhibits a measured minimum loss of 110 dB/km, very close to the theoretical limit of 106 dB/km. Molecular vibrations of aliphatic hydrocarbons in PMMA are the dominant intrinsic loss factor in optical polymer waveguides. The fundamental CH vibration occurs at 3.2 μm. The attenuation loss in the visible wavelength region is affected mainly by the 5th to 7th high harmonics of CH absorption. At the 650 nm window, CH absorption contributes about 90 dB/km to the total loss. In the near-infrared region, the minimum loss exceeds 10⁴-10₅ dB/km, thereby excluding standard optical polymers and RE chromophore structures based on them for use at the three telecommunications wavelengths of 850, 1300, and 1550 nm.

The intensities of the harmonic absorption bands decrease by one order of magnitude with each successive harmonic. If hydrogen is replaced with a more massive atom, the wavelengths of the fundamental vibration and subsequent harmonics would be shifted to longer wavelength regions. The order of higher harmonies which affects the near-infrared region would be higher, resulting in significant decreases in vibrational absorption.

Indeed, when the short wavelength O—H and C—H bonds are replaced by C—F bonds having a markedly longer fundamental stretch vibration at 10 μm, the resulting fluoropolymer waveguide exhibits a reduced loss of 10 dB/km with a practically flat dispersion over the near-infrared range. The primary contributing factors to the fluoropolymer loss are wavelength-independent structural waveguide imperfections and Rayleigh scattering, α_{R}=9.5(568/λ)⁴ dB/km, as based on measurements of fluorinated polymer waveguides. Losses attributed to electronic absorption are usually negligible as are absorptions from molecular vibrations. The C—F vibrational overtones are basically minimal in the visible region and have strengths, in the near infrared range typically of much less than 1 dB/km even up to near 1500 nm. Consequently, the total theoretical loss of a perfluorinated polymer waveguide approaches 10 dB/km well into the near-infrared and is less than 25 dB/km over most of the visible spectrum.

Varieties of fluoropolymers for passive optical waveguides have been developed for direct use, including, for example, ether-, perfluoromethyl-, and chloro-substituted polytetrafluoroethylenes, acrylates, silicones, polyimides, and co- and ter-polymers of (polytetrafluoroethylene) PTFE, and polyvinylidene fluoride (PVDF).

The replacement of O—H and C—H bonds with C—F bonds in the polymer fiber waveguide core materials helps over all radiative efficiency of the RE systems. The O—H stretch (˜3600 cm⁻¹) and C—H stretch (˜3200 cm⁻¹) vibrations play a dominant role in phonon-assisted, nonradiative removal of electronic excitation energy from excited RE ions. Such nonradiative decay of RE metastable-states reduces radiative efficiency and, consequently, degrades amplifier device performance. Phonon-assisted decay decreases exponentially with increased number of phonons required to span the energy gap between the metastable state and the ground state. In the new RE perfluoro polymers, the high frequency O—H and C—H bonds are replaced by C—F bonds that possess considerably reduced frequency vibrations (˜1000-1200 cm⁻¹), and as a consequence, long metastable(˜1-10 ms) lifetimes for the RE sites.

Disclosed is the design and synthesis of two general classes of high optical transparency RE perfluoro polymers for optical amplification applications (FIG. 3). The basic perfluoro phosphate structure-avoids the introduction of O—H and C—H bonds and utilizes C—F bonds. The Er³⁺ ion concentration in these novel polymers is relatively high on the order of 10²¹ ions/cm³. Also disclosed is the use of commercially available fluoropolymers for cladding materials with the new RE perfluoro polymers. In addition to Er³⁺, both single as well as combinations of RE metal ions can be encapsulated at high concentrations in the basic polymer structure.

The radiative properties of the new materials have been measured and characterized. The basic structure of these RE chromophores is composed of an isolated single RE element encapsulated by a molecular “coordination shell.” To create such a shell, perfluorinated organic phosphinate ligands are used With coordinating donor atoms, such as oxygen, to chemically bond to the RE ions which not only isolates the RE ion but also forms a physico-chemical barrier for the RE ion. These RE polymers are compatible with high-temperature perfluorinated polymers suitable as passive cladding materials. RE concentrations of ˜10²⁰-10²¹ ions/cm³˜10% wt RE ion have been achieved with no undesirable effects such as clustering and lifetime quenching. These relatively high concentration figures are to be compared to the 0.1% limit common to silica glasses and inorganic crystals.

The optical properties of the Er³⁺ perfluoro polymers have been evaluated using Judd-Ofelt analyses in order to obtain important radiative lifetimes and emission cross-sections for transitions to the metastable state. In brief, the results for several cm length polymer waveguides are comparable in performance to that of Er³⁺ doped silica glasses commonly used in 40 m length commercial EDFAs. The results provide further basis for the selected approach of RE perfluoro polymer materials.

Attached are examples based on erbium. The methods described are the same methods used for all the other rare earth ions such as lanthanum, cerium, praseodymium, neodymium, promethium, samarium, europium, gadolinium, terbium, dysprosium, holmium, erbium, thulium, ytterbium; and lutetium, as well as aluminum.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A polymer composition comprising:
a polymer comprising at least one unit comprising {X[DDZRR′]₃}ₙ, where:
X is a rare earth element;
D is one of the elements of Group VI_{A};
Z is one of the elements of Group V_{A};
R is a first fully halogenated organic group;
R′ is a second fully halogenated organic group; and
at least one of a perfluoropolymer, a fluoropolymer, and an optical polymer.

2. A polymer according to claim 1, wherein X is chosen from lanthanum, cerium, praseodymium, neodymium, promethium, samarium, europium, gadolinium, terbium, dysprosium, holmium, erbium, thulium, ytterbium, lutetium and aluminum.

3. A polymer according to claim 1, wherein R and R′ are fluoroalkyl chains of a general composition CₓF₂ₓ₊₁ where x≧1.

4. The polymer according to claim 1, wherein R equals R′.

5. The polymer according to claim 1, wherein each of the first and second fully or halogenated organic groups comprises at least one of the group of fluorine, chlorine, bromine, and mixtures thereof.

6. The polymer according to claim 5, wherein each of the first and second fully halogenated organic groups comprises fluorine.

7. The polymer according to claim 1, wherein D is the same or different and is oxygen sulfur.

8. The polymer according to claim 1, wherein Z is chosen from nitrogen and phosphorous.

9. The polymer according to claim 1, wherein the perfluoropolymer is chosen from poly[2,2-bistrifluoromethyl-4,5-difluoro-1,3-dioxole-co-tetrafluoroethylene and poly[2,3-(perfluoroalkenyl)perfluorotetrahydrofuran.

10. The polymer according to claim 1, wherein the fluoropolymer chosen from tetraflouroethylene/hexafluoropropylene/vinylidene copolymers, fluorinated acrylates, fluorinated methacrylates, fluorinated polymides, and fluorinated polyarylethers.

11. The polymer according to claim 1, wherein the optical polymer is chosen from polymethylmethacrylate, polystyrene, polycarbonate, and norbornene polymers.

12. The polymer according to claim 1, further comprising an amorphous polymer structure.

13. The polymer according to claim 1, wherein a ratio of the one of the perfluoropolymer, the fluoropolymer, and the optical polymer to the polymer is approximately 6 to 1 by weight.

14. A polymer blend comprising
a polymer comprising at least one unit comprising {XY[DDZRR′]₃}ₙ, where:
X is a first rare earth element;
Y is a second rare earth element;
D is one of the elements of Group VI_{A};
Z is one of the elements of Group V_{A};
R is a first fully halogenated organic group;
R′ is a second fully halogenated organic group; and
at least one of a perfluoropolymer, a flouropolymer, and an optical polymer.

15. The polymer blend according to claim 14, wherein X is chosen from lanthanum, cerium, praseodymium, neodymium, promethium, samarium, europium, gadolinium, terbium, dysprosium, holmium, erbium, thulium, ytterbium, lutetium and aluminum.

16. The polymer blend according to claim 14, wherein Y is chosen from lanthanum, cerium, praseodymium, neodymium, promethium, samarium, europium, gadolinium, terbium, dysprosium, holmium, erbium, thulium, ytterbium, lutetium, and aluminum.

17. The polymer blend according to claim 14, wherein X and Y are different rare earth elements.

18. The polymer blend according to claim 14, wherein R and R′ are fluoroalkyl chains of a general composition CₓF₂ₓ₊₁ where x≧1.

19. The polymer blend according to claim 18, wherein R equals R′.

20. The polymer blend according to claim 14, wherein each of the first and second fully halogenated organic groups comprising at least one of fluorine, chlorine, bromine, and mixtures thereof.

21. The polymer blend according to claim 20, wherein each of the first and second fully halogenated organic groups comprises fluorine.

22. The polymer blend according to claim 14, wherein a ratio of X to Y is between approximately 20 to 1 and 20 to 3.

23. The polymer blend according to claim 22, wherein the ratio of X to Y is approximately 20 to 2.

24. The polymer blend according to claim 14 wherein D is one of oxygen and sulfur.

25. The polymer blend according to claim 14, wherein Z is one of nitrogen and phosphorous.

26. The polymer blend according to claim 14, wherein the perfluoropolymer is chosen from poly[2,2-bistrifluoromethyl-4,5-difluoro-1,3-dioxole-co-tetrafluoroethylene and poly[2,3-(perfluoroalkenyl)perfluorotetrahydrofuran.

27. The polymer blend according to claim 14, wherein the fluoropolymer is chosen from tetraflouroethylene/hexafluoropropylene/vinylidene copolymers, fluorinated acrylates, fluorinated methacrylates, fluorinated polymides, and fluorinated polyarylethers.

28. The polymer blend according to claim 14, wherein the optical polymer is chosen from polymethylmethacrylate, polystyrene, polycarbonate, and norbornene polymers.

29. The polymer blend according to claim 14, further comprising an amorphous polymer structure.

30. The polymer blend according to claim 14, wherein a ratio of the one of the perfluoropolymer, the fluoropolymer, and the optical polymer to the polymer is approximately 6 to 1 by weight.

31. A polymer blend formed by:
dissolving a rare earth perfluoropolymer in a first solvent, the rare earth perfluoropolymer having a general composition {XY[DDZRR′]₃}ₙ, where:
X is a first rare earth element;
Y is a second rare earth element;
D is one of the elements of Group VI_{A};
Z is one of the elements of Group V_{A};
R is a first fully halogenated organic group;
R′ is a second fully halogenated organic group; and
forming a first solution; and
dissolving a copolymer in a second solvent to form a second solution, the first and second solvent s being miscible cosolvents;
combining the first and second solutions; and
dissolving the first and second solvents.

32. The polymer blend according to claim 31, wherein the copolymer is chosen from a perfluoropolymer, a fluoropolymer, and an optical polymer.

33. The polymer blend according to claim 31, wherein the first solvent is the same as the second solvent.

34. The polymer blend according to claim 33, wherein the first and second solvents are dimethyl acetamide.

35. The polymer blend according to claim 31, wherein a weight ratio of the rare earth perfluoropolymer and the copolymer after dissolving the first and second solvents is approximately 1 to 6.

36. A polymer blend formed by:
Dissolving a rare earth perfluoropolymer in a first solvent, the rare earth perfluoropolymer comprising at least one unit comprising {X[DDZRR′]₃}ₙ, where:
X is a rare earth element:
D is at least one of the elements of Group VI_{A};
Z is at least one of the elements of Group V_{A};
R is a first fully halogenated organic group;
R′ is a second fully halogenated organic group;
Wherein the rare earth perfluoropolymer and the copolymer have similar processing windows and the rare earth perfluoropolymer and the copolymer are blended in a shearing process.

37. The polymer blend according to claim 36, wherein each of the rare earth perfluoropolymer and the copolymer are in the form of one of powder and pellets.

38. The polymer blend according to claim 37, wherein the shearing process is a screw extrusion.

39. A polymer blend formed by:
dissolving a rare earth perfluoropolymer in a first solvent, the rare: earth perfluoropolymer comprising at least one unit comprising {X[DDZRR′₃}ₙ, where:
X is a rare earth element;
D is one of the elements of Group VI_{A};
Z is one of the elements of Group V_{A};
R is a first fully halogenated organic group;
R′is a second fully halogenated organic group; and
forming a first solution; and
dissolving a copolymer in a second solvent to form a second solution, the first and second solvents being miscible cosolvents;
combining the first and second solutions; and
dissolving the first and second solvents.

40. The polymer blend according to claim 39, wherein the copolymer is chosen from a perfluoropolymer, a flouropolymer, and an optical polymer.

41. The polymer blend according to claim 39, wherein the first solvent is the same as the second solvent.

42. The polymer blend according to claim 41, wherein the first and second solvents are dimethyl acetamide.

43. The polymer blend according to claim 39, wherein a weight ratio of the rare earth perfluoropolymer and the copolymer after dissolving the first and second solvents is approximately 1 to 6.

44. The polymer blend according to claim 43, wherein each of the rare earth perfluoropolymer and the copolymer are in the form of one of powder and pellets.

45. The polymer blend according to claim 43, wherein the shearing process is a screw extrusion.

46. A method of manufacturing a polymer blend comprising:
providing a rare earth perfluoropolymer in a first solvent, the rare earth perfluoropolymer comprising at least one unit comprising {XY[DDZRR′]₃}ₙ, where:
X is a first rare earth element;
Y is a second rare earth element;
D is one of the elements of Group VI_{A};
Z is one of the elements of Group V_{A};
R is a first fully halogenated organic group;
R′ is a second fully halogenated organic group; and
providing a copolymer in a second solvent, the first and second solvents being miscible cosolvents;
combining the first and second solutions; and
dissolving the first and second solvents.

47. A method of manufacturing a polymer blend comprising:
providing a rare earth perfluoropolymer in a first solvent, the rare earth perfluoropolymer comprising at least one unit comprising {X[DDZRR′]₃}ₙ, where:
X is a rare earth element;
D is one of the elements of Group VI_{A};
Z is one of the elements of Group V_{A};
R is a first fully halogenated organic group;
R′ is a second fully halogenated organic group; and
providing a copolymer in a second solvent, the first and second solvents being miscible cosolvents;
combining the first and second solutions; and
dissolving the first and second solvents.
